(19) United States
(12) Patent Application Publication
(10) Pub. No.: US 2014/0355536 A1
(43) Pub. Date: Dec. 4, 2014

(54) SYSTEM AND METHOD PROVIDING FIXED MOBILE CONVERGENCE VIA BONDED SERVICES

(71) Applicants: PRAVEEN VASANT MULEY, MOUNTAIN VIEW, CA (US); WIM HENDERICKX, WESTERLO (BE); VACHASPATHI PETER KOMPELLA, CUPERTINO, CA (US); FRANCOIS L BOUCHARD, SAN JOSE, CA (US); SUDEEP SHRIKRISHNA PATWARDHAN, FREMONT, CA (US); KIRAN KUMAR REDDY MUNDLA, SANTA CLARA, CA (US); THIRUMANI RAJAN KASI RATNAM, SUNNYVALE, CA (US)

(72) Inventors: PRAVEEN VASANT MULEY, MOUNTAIN VIEW, CA (US); WIM HENDERICKX, WESTERLO (BE); VACHASPATHI PETER KOMPELLA, CUPERTINO, CA (US); FRANCOIS L BOUCHARD, SAN JOSE, CA (US); SUDEEP SHRIKRISHNA PATWARDHAN, FREMONT, CA (US); KIRAN KUMAR REDDY MUNDLA, SANTA CLARA, CA (US); THIRUMANI RAJAN KASI RATNAM, SUNNYVALE, CA (US)

(73) Assignees: ALCATEL LUCENT, BOULOGNE BILLANCOURT (FR); ALCATEL LUCENT USA INC., MURRAY HILL, NJ (US)

(21) Appl. No.: 14/295,383

(22) Filed: Jun. 4, 2014

Related U.S. Application Data
(60) Provisional application No. 61/831,003, filed on Jun. 4, 2013.

(51) Int. Cl. H04W 72/04; H04W 28/02

(52) U.S. Cl. CPC H04W 72/0493; H04W 28/0215
USPC 370/329

(57) ABSTRACT

Method, system and apparatus for identifying and binding together in one session multiple data bearing paths through various access technologies between a Packet Gateway (PGW) and Customer Premises Equipment (CPE) to form thereby a bonded service combining wireless and wireline bearers.

### CROSS-REFERENCE TO RELATED APPLICATIONS

This application claims priority to U.S. Provisional Patent Application Ser. No. 61/831,003 (Attorney Docket No. 814349-US-PSP), entitled “SYSTEM AND METHOD FOR BONDING ACCESS,” which is hereby incorporated by reference in its entirety.

### TECHNICAL FIELD

The invention relates generally to managing network resources and, more specifically but not exclusively, to adapting and enforcing policies across multiple access technologies and termination points.

### BACKGROUND

User equipment (UE) such as smart phones, tablet computers and the like are typically capable of communicating via multiple access technologies, such as various Wi-Fi networks (e.g., 802.11x networks and the like) as well as various mobile network technologies (e.g., 3GPP, LTE and the like). Similarly, Customer Premises Equipment (CPE) such as Residential Gateways (RGs), set-top boxes (STBs), routers, switches and other residential/enterprise gateway devices may also be capable of communicating via multiple access technologies including both wireless access technologies (Wi-Fi, 3GPP, LTE etc.), along with various wireline access technologies such as Digital Subscriber Line (DSL), cable, optical networks and so on.

### SUMMARY

Various deficiencies of the prior art are addressed by the present invention of method, apparatus and system for identifying and binding together in one session multiple data bearing paths through various access technologies (e.g., DSL, Cable, Wi-Fi, LTE, 3G etc.) between a Packet Gateway (PGW) and Customer Premises Equipment (CPE) to form thereby a bonded service combining wireless and wireline bearers. The PGW allocates downstream traffic flows among multiple downstream bearers in a policy-driven manner. Optionally, the CPE allocates upstream traffic flows among multiple upstream bearers in a policy driven manner. The bonded service operation of the PGW and CPE is not relevant to the operation of Service Data Flow (SDF) and Application Flow (AF) endpoints, such as User Equipment (UE) communicating with the CPE to receive traffic from various remote/public servers.

A method of providing bonded services according to one embodiment comprises determining, at a gateway device configured to support a User Equipment (UE) data plane session having multiple bearers, an allocation of UE traffic communicated by the multiple bearers according to policy information received by the gateway device, wherein each bearer is associated with a different IP Connectivity Access Network (IP-CAN); and adapting UE traffic communicated via the multiple bearers according to the determined allocation.

### BRIEF DESCRIPTION OF THE DRAWING

The teachings of the present invention can be readily understood by considering the following detailed description in conjunction with the accompanying drawings, in which:

FIGS. 1-3 depict high-level block diagrams of systems benefiting from various embodiments;

FIGS. 4A, 4B and 5 depict flow diagrams of methods according to various embodiments;

FIG. 6 depicts a graphical representation of a data plane model useful in understanding the various embodiments;

FIG. 7 depicts a high-level block diagram of a system benefiting from various embodiments; and

FIG. 8 depicts a high-level block diagram of a general purpose computing device suitable for use in various embodiments.

To facilitate understanding, identical reference numerals have been used, where possible, to designate identical elements that are common to the figures.

### DETAILED DESCRIPTION

The invention will be primarily described within the context of a mechanism for policy-based steering of data toward user equipment (UE) capable of receiving data via multiple paths (single-homed or multi-homed), 10 wherein data associated with multiple service data flows (SDFs) for a UE are allocated across multiple paths by a gateway device in accordance with policy information provided to the gateway device.

Various embodiments contemplate a policy-based downstream traffic steering mechanism operable at a gateway device such as a Service Gateway (SGW), a Packet Gateway (PGW) or other provider equipment (PE).

Various embodiments contemplate a policy-based upstream traffic steering mechanism operable at a gateway device such as a home or enterprise gateway device terminating path associated with multiple different access technologies.

Generally speaking, various embodiments provide a mechanism for identifying and binding together multiple data bearing paths through various access technologies (e.g., DSL, Cable, Wi-Fi, LTE, 3G etc.) between a Packet Gateway (PGW) and Customer Premises Equipment (CPE) to form thereby a bonded service combining wireless and wireline bearers. The PGW allocates downstream traffic flows among multiple downstream bearers in a policy-driven manner. Optionally, the CPE allocates upstream traffic flows among multiple upstream bearers in a policy driven manner. The bonded service operation of the PGW and CPE is not relevant to the operation of Service Data Flow (SDF) and Application Flow (AF) endpoints, such as User Equipment (UE) communicating with the CPE to receive traffic from various remote/public servers.

Various embodiments advantageously operate to increase throughput between a Packet Gateway (PGW) and/or Broadband Network Gateway (BNG) and Customer Premises Equipment (CPE) such as a residential/enterprise gateway by forming a multi-bearer bonded service therebetween using various wireless and/or wireline access technologies (e.g., DSL, cable, Wi-Fi, LTE, 3G and the like). Policies may be applied at a residential or enterprise gateway for uplink traffic and/or at a PGW/SGW or combined PGW/BNG for downlink traffic to spread traffic among multiple bearers within the context of bonded services. Various embodiments advantageously provide inherent error redundancy.

Various embodiments adapt and enforce policies across multiple access technologies and termination points. For example, some embodiments identify and bond together all available access technologies in a subscriber management system (combined wireless and wire line) and enforce policies for the downlink traffic. Various embodiments spread traffic loads across multiple access technology bearers using various techniques, such as hashing techniques and other allocation techniques. Bonded service formation and structure, allocation of traffic among bearers and so on may be policy driven and dynamically updated as desired by the network operator, subscriber management system, network management system or other entity.

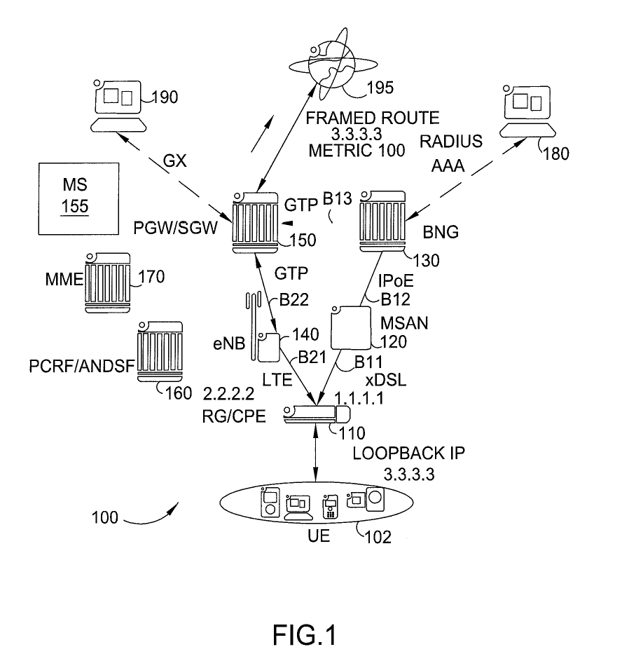

FIG. 1 depicts a high-level block diagram of a system benefiting from various embodiments. The system 100 of FIG. 1 will be described within the context of a specific use case in which CPE 110 comprises a Set-Top Box (STB) including both Digital Subscriber Line (DSL) and 3GPP/LTE access network capabilities. However, other use cases are also contemplated as will be discussed in more detail below. For example, within the context of a residential broadband, additional capacity can be added to a fixed cable television or DSL line by using LTE to increase upstream bandwidth and/or downstream bandwidth. Similarly, within the context of enterprise broadband, improved resilience and survivability may be provided via multiple bonded bearers.

Generally speaking, the system 100 of FIG. 1 contemplates Residential Gateway (RG) or other Customer Premises Equipment (CPE) 110 in communication with User Equipment (UE) 102 to provide various network services thereto. The CPE 110 communicates with a public network gateway device 150 such as a Packet Gateway (PGW) and/or Service Gateway (SGW) via at least two different access network technologies, such as a wireless access network and a wireline access network. It will be appreciated that while only one wireless access network and one wireline network are shown within the context of the system 100 of FIG. 1, more and/or different access networks may also be employed within various embodiments. Further, the various embodiments are applicable to any combination of two or more access technologies, which access technologies may comprise wireless access networks only, wireline access networks only or a combination of wireless and wireline access networks.

CPE 110 communicates with PGW/SGW 150 via a wireline access network, illustratively a xDSL access network, as well as a wireless access network, illustratively a 3GPP/LTE access network.

The xDSL access network comprises a Multi-Service Access Node (MSAN) 120 supporting communications between the CPE 110 and a Broadband Network Gateway (BNG) 130. The BNG 130 communicates with the PGW/SGW 150 as well as an Authentication, Authorization and Accounting (AAA) server 180, illustratively a RADIUS server. The xDSL access network may include or be associated with various other management and/or control entities (not shown) as known to those skilled in the art.

The 3GPP/LTE access network comprises eNodeBs 140 (one eNodeB shown) supporting communications between the CPE 110 and the PGW/SGW 150. Also depicted is a policy control entity 160 illustratively implementing a Policy and Charging Rules Function (PCRF) as well as a Access Network Discovery and Selection Function (ANDSF). It will be appreciated that the PCRF and ANDSF may be implemented in different entities or servers.

In operation, the PGW/SGW 150 and RG/CPE 110 establish a data plane session therebetween in which the data plane provides two default bearers; namely, a first bearer tunnel through the first access network and a second bearer tunnel through the second access network. For example, the first tunnel traversing the xDSL access network may comprise a bearer link B11 between the RG/CPE 110 and the MSAN 120, a bearer link B12 between the MSAN 120 and the BNG 130, and a bearer link B13 between the BMG 130 and the PGW/SGW 150. Similarly, the second tunnel traversing the 3GPP/LTE access network may comprise a bearer link B21 between the RG/CPE 110 and an eNodeB 140, and a bearer link B22 between the eNodeB 140 and the PGW/SGW 150.

In various embodiments, the tunnels, bearers and related session/traffic signaling conform to the General Packet Radio Service (GPRS) Tunneling Protocol (GTP). Other protocols may be also be used.

The PCRF/ANDSF 160 implements both PCRF and ANDSF. The PCRF provides dynamic management capabilities by which the service provider may manage rules related to UE user or subscriber Quality of Service (QoS) requirements, rules related to charging for services provided to the UE, rules related to mobile network usage, provider equipment management and so on. The ANDSF assists the UE 102 and RG/CPE 110 in discovering access networks such Wi-Fi networks, 3GPP/LTE networks and the like and to provide rules governing connection policies associated with these access networks.

A Mobility Management Entity (MME) 170 provides mobility management functions in support of mobility of UEs 102 as well as RG/CPE 110. The MME 170 supports the various eNodeBs 140 using, illustratively, respective S1-MME interfaces which provide control plane protocols for communication between the MME 170 and the eNodeBs 140.

In various embodiments, a management system 155 provides management functions for managing one or more wireless and/or wireline networks, such as the described 3GPP/LTE network. The MS 155 may communicate with the network in any suitable manner. In various embodiments, for example, MS 155 may communicate with network elements via a communication path which may be in-band or out-of-band with respect to the various network elements. The MS 155 may be implemented as a general purpose computing device or specific purpose computing device, such as further described below. The MS 155 may interact with the PCRF/ANDSF 160 to provide management instructions, adapt policies and perform various other functions.

Various embodiments contemplate that one or both of the PCRF and ANDSF provides policy information to PGW/SGW 150 and, optionally, RG/CPE 110 such that these entities are configured to support bonded services, provide policy-based path or bearer selection/routing rules for traffic flow assignment and so on as described herein with respect to the various embodiments. In various embodiments, PCRF-related actions pertain to policy delivery with respect to the PGW/SGW 150, while ANDSF-related actions pertain to policy delivery with respect to the RG/CPE 110 and/or UEs 102.

The UEs 102 may comprise devices such as desktop computers, laptop computers, tablet computers, set-top boxes, smart phones or any other mobile or fixed device capable of communicating with the RG/CPE 110. In various embodiments, UEs 102 may be multi-homed to a gateway device such as the PGW/SGW 150 via a first path or tunnel supported by the RG/CPE 110 and a second path or tunnel directly through a eNodeB, Wi-Fi Access Point (WAP) or other wireless access point.

The PGW/SGW 150 operates to forward downstream traffic to the RG/CPE 110 via the multiple access network technologies in accordance with a policy-driven allocation between multiple downstream tunnels or bearers forming a bonded service. The RG/CPE 110 operates to forward upstream traffic to the PGW/SGW 150 via one or more of the multiple access network technologies, optionally in accordance with a policy driven allocation between multiple upstream bearers forming a bonded service.

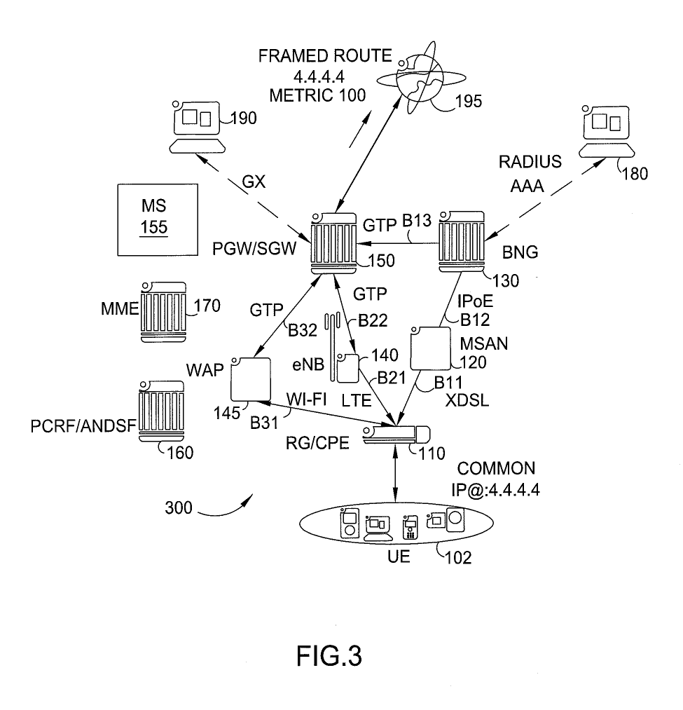

Specifically, the system 100 of FIG. 1 comprises, illustratively, user equipment (UE) 102, a Residential Gateway (RG) or other Customer Premises Equipment (CPE) 110, to receive various data services thereby. The RG/CPE 110 is associated with a plurality of access network technologies, illustratively a 3GPP/LTE wireless access network and a Digital Subscriber Line (DSL) wireline access network. While only two access networks are shown within the context of the system 100 of FIG. 1, more and/or different access networks may also be employed within various embodiments, such as described in more detail below with respect to FIG. 3.

Various embodiments provide a mechanism for policy-based steering of user flows/applications between multiple bearers at the PGW/SGW 150, RG/CPE 110 and/or UE 102. Policies may be based upon (1) traffic flows (e.g., streaming media, telephony, data transfer, secure session etc.), (2) applications (e.g., Netflix, Gmail, WebEx etc.), (3) entities (e.g., gold/silver/bronze level subscribers, content providers, service providers etc.) and the like associated with respective policies identifying and invoking preferred access technologies.

Any of the various embodiments discussed above and herein may be implemented within the context of one or more networks adapted according to the embodiments, such as a network adapted according to any of the embodiments, a system according to any of the embodiments, hardware and/or software according to any of the embodiments, a management entity or network management system according to any of the embodiments, a data center or computational resource according to any of the embodiments and so on.

While primarily discussed within the context of a Long Term Evolution (LTE) network, those skilled in the art and informed by the teachings herein will realize that the inventions are also well suited for use with other types of wireless networks (e.g., 3G networks, 2G networks, UMTS, EV-DO, WiMAX, 802.11x and so on) and in various combinations, wireline networks or combinations of wireless and wireline networks. Thus, the various connectors, sites, nodes, network elements and so on discussed herein with respect to LTE embodiments may also be considered as being discussed with respect to similar elements in other network embodiments (e.g., eNodeB in LTE or 4G network similar to Base Station in 3G network, etc.).

It is noted that the PGW/SGW 150 and BNG 130 are depicted in FIG. 1 as independent entities in communication with each other via, illustratively, a GTP tunnel. In various embodiments, the PGW/SGW 150 and BNG 130 are integrated within the same physical chassis to provide a converged BNG/packet core solution.

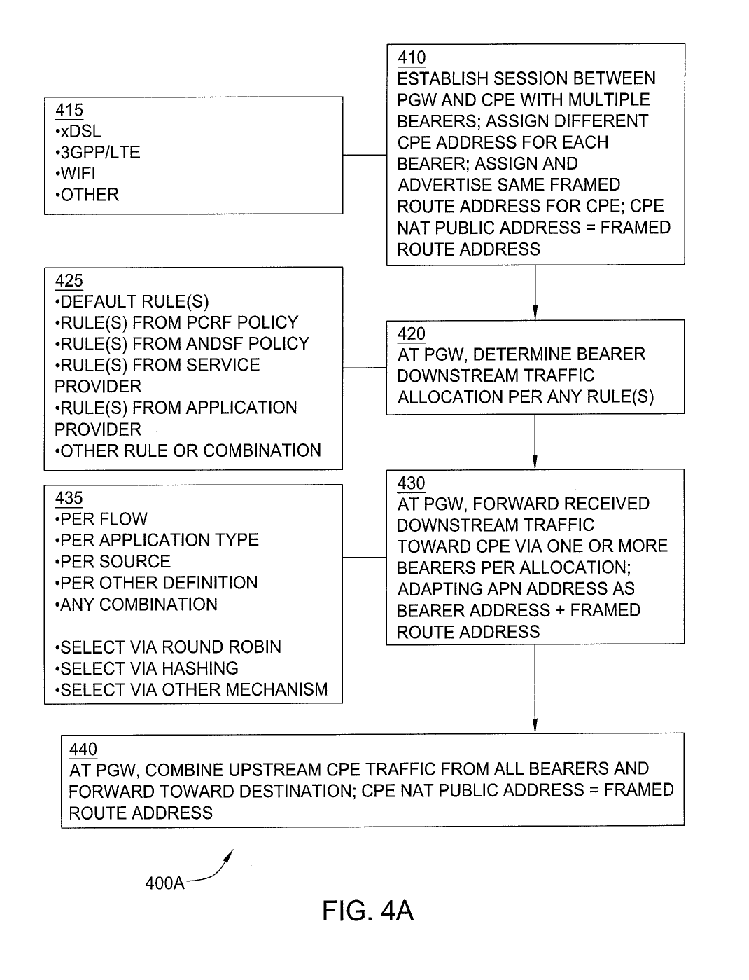

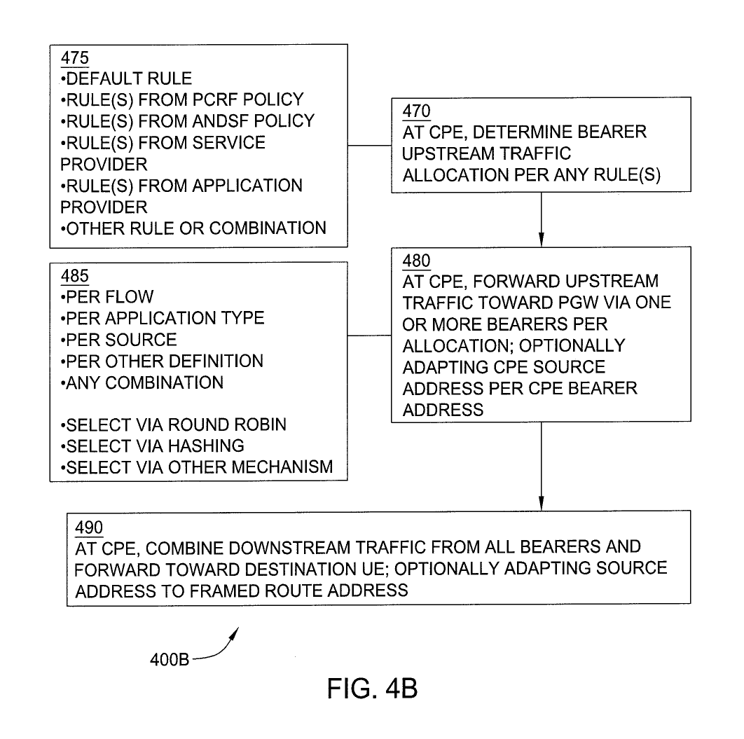

The system 100 depicted above with respect to FIG. 1 further depicts various exemplary CPE-related address indicators associated with data paths useful in explaining framed route embodiments such as described below with respect to FIG. 4. The depicted CPE-related address indicators include a framed route address 3.3.3.3 (as well as the capacity metric depicted as 100) for traffic between the PGW/SGW 150 and public network 195, an xDSL link address of 1.1.1.1, an LTE link address of 2.2.2.2 and a CPE loopback address of 3.3.3.3.

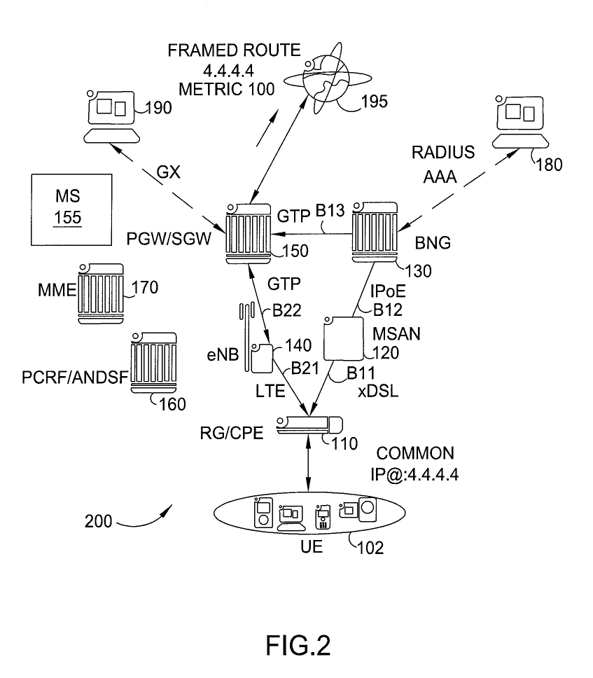

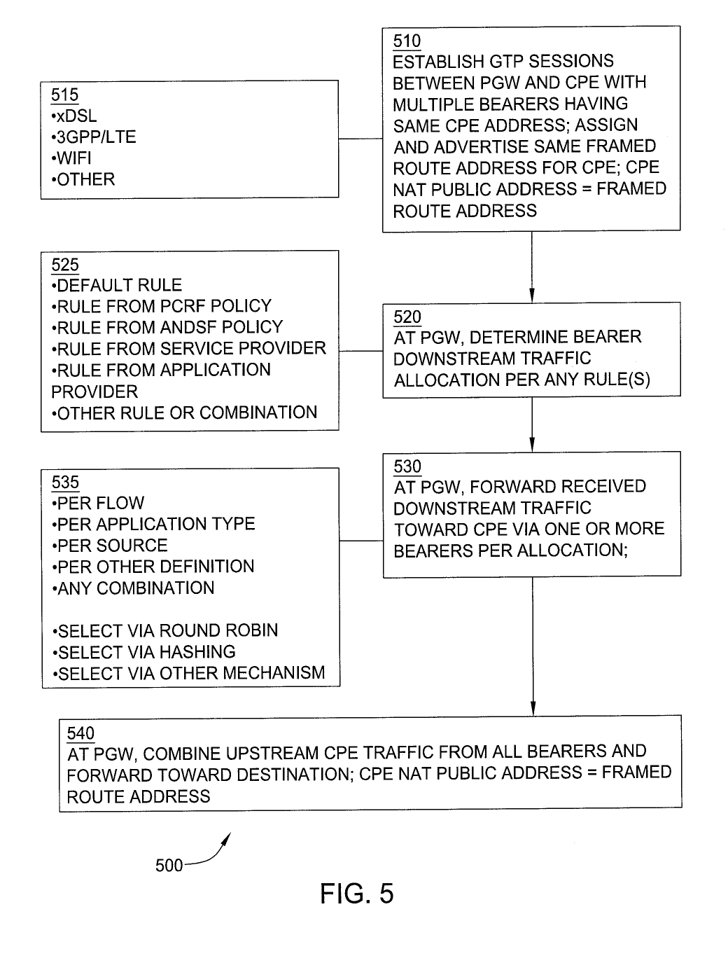

FIG. 2 depicts a high-level block diagram of a system 200 substantially the same as the system 100 depicted with respect to FIG. 1, except that FIG. 2 further depicts various exemplary CPE-related address indicators useful in explaining embodiments that avoid problems associated with UE interaction, such as associated with IP Flow Mobility and Seamless Offload (IFOM) techniques, such as discussed in more detail below with respect to FIG. 5. The depicted CPE-related address indicators include a framed route address 4.4.4.4, which address is also used to identify the CPE in each of the access networks. That is, only one address is used to identify the CPE in these embodiments.

FIG. 3 depicts a high-level block diagram of a system 300 substantially the same as the system 200 depicted with respect to FIG. 2, except that FIG. 3 further discloses a third access network and related bearer path; namely, a Wireless Access Point (WAP) 145 communicating with RG/CPE 110 via a bearer B31 and with PGW/SGW 150 via a bearer B32. The various embodiments described herein with respect to allocation of traffic associated with bearers through two access networks are readily adapted where three or more bearers through multiple access networks are provided.

Generally speaking, the various embodiments contemplate policy having driven allocation of traffic across multiple bearers, where each bearer is associated with a different IP Connectivity Access Network (IP-CAN). However, in various embodiments it is contemplated that some of the bearers may be associated with the same IP-CAN.

Bonded Services

In various embodiments, based on Access Point Name (APN) configuration, the PGW determines the bonded property of the APN and includes an AVP to communicate the bonded property to the PCRF in an initial Credit Control Request (CCR-I). As an example, this could re-use IP-CAN-type with new type as BONDED. Further, a Bonded IP-CAN-type means an IP-CAN session where the UE may reach the EPC (PGW) over a 3GPP-EPS IP-CAN-Type and/or over a Non-3GPP-EPS IP-CAN-Type, thus with a possible simultaneous access over both IP-CAN-Type. In addition, routing decisions are taken by a gateway network element (not a UE).

In various embodiments, Gx reporting from PCEF to the PCRF may indicate whether the UE or CPA is accessing the PGW over 3GPP access, over Non 3GPP access or over both kinds of access simultaneously. Gx interface definition may be adapted to indicate that an updated Credit Control Request (CCR-U) may contain a RAT-Type or AT-Type indicator associated with a 3GPP-EPS IP-CAN-Type or a Non-3GPP-EPS IP-CAN-Type. In various embodiments, the presence of both RAT-Type in CCR-U will not be treated as inter-RAT handover but as addition of a RAT or AT.

In various embodiments, the PCRF includes an IP-CAN-Type in the commands it is sending. Absence of the IP-CAN-Type in a PCRF command is interpreted to mean that the command applies to all IP-CAN-Type on the bonded IP CAN session. The presence of a given IP-CAN-Type in a PCRF command is interpreted to mean that the command applies only to this IP-CAN-Type.

In various embodiments, for UEs capable of supporting the BONDED property, the UE may communicate this property by including a new container identifier, for example, a bonded-support-request (MS to network) and corresponding bonded-support (network to MS). Similarly, a UE capable of supporting primary/backup support can communicate a MS to network redundancy-support-request (optionally with indication of a preferred Pdn connection) Network to MS redundancy support.

Various embodiments, the allocation or routing decision algorithm takes into account various factors and policies.

In various embodiments, as long as both legs (3GPP/N3GPP) of the bonded service are established, for one direction (UL/DL), a given IP flow should be carried by a unique IP leg. This operates to avoid the condition wherein TCP packets/segments with a higher SN arrive before TCP packets/segments with a lower SN which have been transmitted via a faster error.

In various embodiments, flow based routing policies are provided. Specifically, PCRF policies may associate a Service Data Flow (SDF=set of IP filters) or an application flow with a preferred IP-CAN-Type (3GPP/non-3GPP) and allocate/route accordingly.

In various embodiments, global routing policies are provided. Specifically, global routing policies may be applied when no flow based routing policies are provided for traffic that must be allocated by, illustratively, the PGW. Some examples of global policies are as follows:

(1) A priority and a priority throughput are associated with one IP-CAN-Type such as a least cost IP-CAN-Type (likely to be N3GPP (DSL).

(2) A relative load factor (%) provided for different RAT-Type combinations where each of the RAT-Type combinations corresponds to a combination (RAT-Type of 3GPP IP-CAN-Type, RAT-Type of N3GPP IP-CAN-Type and so on). This relative load factor may be used in various embodiments to establish a configuration (active/stand-by) where all traffic is sent on a given IP-CAN-Type.

(3) A Priority IP-CAN-Type, in which priority throughput and relative load factors may be either locally configured on the PGW, or sent by the PCRF over Gx. In the latter case, they are associated with the Gx session and override the locally configured value.

Various routing/allocations algorithms may be configured to subject traffic to global Routing policies. In particular, in various embodiments the PGW measures the actual throughput on each of the bearers and, as long as the actual throughput on a priority bearer or leg is below the priority throughput defined for that bearer or leg, the traffic is sent on the priority bearer or leg. Once the priority access bearer or the like is loaded up to its priority throughput threshold level, the PGW uses the % factor associated with the IP-CAN-Type (3GPP/N3GPP) to ensure load sharing.

### Framed Route Embodiment

FIG. 4 depicts a flow diagram of a method according to various embodiments. Specifically, FIG. 4 depicts a framed route mechanism suitable for use within the systems of FIGS. 1-3, wherein actions performed at the PGW/SGW 150 are primarily depicted in steps 410-440 of FIG. 4A, while actions performed at the RG/CPE 110 are primarily depicted in steps 460-490 of FIG. 4B.

At step 410, a session is established between the PGW and the CPE via multiple bearers, illustratively one bearer or GTP tunnel traversing each of a wireless access network and wireline access network therebetween. The CPE is assigned a different address for each bearer. Further, a framed route address is assigned to the CPE and advertised as the Natural Address Translation (NAT) public address of the CPE. In this manner, remote network entities such as application servers and the like address traffic to the CPE via the NAT public address (framed route address), while the PGW addresses traffic to the CPE via specific addresses associated with the established bearers. Referring to box 515, the access network may comprise wireline access networks such as xDSL and/or wireless access networks such as 3PP/LTE, Wi-Fi and the like.

At step 420, the PGW determines a bearer downstream traffic allocation for any allocation rules, such as default and/or policy-driven rules. Referring to box 425, the allocation rules may comprise one or more default rules, rules received within policy information from a PCRF or ANDSF, rules received from service providers, application providers or some other entity, as well as other types of rules or combinations of any of these types of rules.

At step 430, the PGW forwards received downstream traffic (e.g., received from the public network 195) toward the CPE via one or more bearers in accordance with the determined allocation. Further, the PGW adapts the APN address of the downstream traffic according to the bearer address and framed route address. Referring to box 435, the allocation may be applied on the basis of various techniques/criteria, such as per flow, per application type, per source, per some other definition or per any combination of these techniques/criteria. Further, allocation may be performed by any mechanism, including round robin, weighted preferences, percentage, hashing, other mechanism and/or any combination of these mechanisms.

At step 440, the PGW combines upstream CPE traffic from all bearers and forwards the combined traffic toward the appropriate destination. That is, the PGW combines upstream traffic received from the PE, combines received traffic, replaces the CPE bearer-related source IP address with the NAT public address or framed route address, and forwards the combined traffic or packets toward their appropriate destination.

Generally speaking, the steps contemplated with respect to the above embodiment are suitable for use within the context of the systems described above with respect to FIGS. 1-3. As an example, xDSL and LTE sessions may be provided as follows:

xDSL: IP over Ethernet (IPoE) session to the BNG→AAA assigns IMSI X based on MAC and default APN xDSL→GTPv2 session/bearer setup to PGW with IP address assignment (1.1.1.1)+framed route 3.3.3.3+Gx session.

LTE: GTPv2/bearer setup with IMSI X, APN LTE→IP address assignment (2.2.2.2)+framed route 3.3.3.3.

Thus, with respect to the PGW, two PDN sessions with same International Mobile Subscriber Entity Identifier (IMSI) are provided, each with a different Access Point Name (APN), wherein the same framed route is used on both PDN sessions. The various embodiments, allocation of traffic between the two access networks may be determined by a number of methods, such as equal-cost multipath (ECMP) hashing within the context of an “any/any” PCC (Policy Control and Charging) rule. Further, other PCC rules may be provided to allocate or direct traffic either via xDSL or LTE.

In various embodiments, one public address associated with the CPE is advertised to public network elements, such as within the context of an IPv6 framed route solution. This one address is used by upstream CPE traffic as a source address for each link or bearer by which upstream traffic is communicated to the PGW.

Further, with respect to the CPE, NAT public IP addresses used for the CPE, and upstream traffic may be passed or otherwise allocated between the two access networks if desired. In various embodiments, substantially all traffic is allocated to a preferential access network (e.g., the xDSL access network), while traffic in excess of a threshold amount is allocated to a secondary access network (e.g., the LTE access network). In various embodiments, upstream traffic is hashed via LTE/xDSL, IPv6 DHCP PD.

Referring to FIG. 4B, at step 470 the CPE determines a bearer upstream traffic allocation for any allocation rules, such as default and/or policy-driven rules. Referring to box 475, the allocation rules may comprise one or more default rules, rules received within policy information from a PCRF or ANDSF, rules received from service providers, application providers or some other entity, as well as other types of rules or combinations of any of these types of rules.

At step 480, the CPE forwards received upstream traffic (e.g., received 30 from the UE 102) toward the PGW via one or more bearers in accordance with the determined allocation. Further, the PGW adapts the CPE source address for upstream traffic in accordance with the CPE bearer related address. Referring to box 485, the allocation may be applied on the basis of various techniques/criteria, such as per flow, per application type, per source, per some other definition or per any combination of these techniques/criteria. Further, allocation may be performed by any mechanism, including round robin, weighted preferences, percentage, hashing, other mechanism and/or any combination of these mechanisms.

At step 490, the CPE combines downstream traffic from all bearers and forwards the combined traffic toward the appropriate destination (e.g., appropriate UE). That is, the CPE combines downstream traffic received from the PGW, combines the received traffic, replaces the bearer-related source IP address with the NAT public address or framed route address, and forwards the combined traffic or packets toward their appropriate destination UE.

FIG. 5 depicts a flow diagram of a method according to various embodiments. Specifically, FIG. 5 depicts a mechanism suitable for use within the systems of FIGS. 1-3.

At step 510, a session is established between the PGW and the CPE via multiple bearers, illustratively one bearer or GTP tunnel traversing each of a wireless access network and a wireline access network therebetween. The CPE is assigned the same IP address for each bearer. Further, the same address is used and advertised as the Natural Address Translation (NAT) public address of the CPE. Referring to box 515, the access network may comprise wireline access networks such as xDSL and/or wireless access networks such as 3PP/LTE, Wi-Fi and the like.

At step 520, the PGW determines a bearer downstream traffic allocation for any allocation rules, such as default and/or policy-driven rules. Referring to box 525, the allocation rules may comprise one or more default rules, rules received within policy information from a PCRF or ANDSF, rules received from service providers, application providers or some other entity, as well as other types of rules or combinations of any of these types of rules.

At step 530, the PGW forwards received downstream traffic (e.g., received from the public network 195) toward the CPE via one or more bearers in accordance with the determined allocation. Further, the PGW adapts the APN address of the downstream traffic according to the bearer address and framed route address. Referring to box 535, the allocation may be applied on the basis of various techniques/criteria, such as per flow, per application type, per source, per some other definition or per any combination of these techniques/criteria. Further, allocation may be performed by any mechanism, including round robin, weighted preferences, percentage, hashing, other mechanism and/or any combination of these mechanisms.

At step 540, the PGW combines upstream CPE traffic from all bearers and forwards the combined traffic toward the appropriate destination. That is, the PGW combines upstream traffic received from the PE, combines received traffic, replaces the CPE bearer-related source IP address with the NAT public address or framed route address, and forwards the combined traffic or packets toward their appropriate destination.

Generally speaking, the steps contemplated with respect to the above embodiment are suitable for use within the context of the systems described above with respect to FIGS. 1-3. As an example, xDSL and LTE sessions may be provided as follows:

xDSL: IPoE session to the BNG→AAA assigns IMSI X based on MAC and APN Y→GTPv2 session/bearer setup to PGW with IP address assignment (4.4.4.4)+Gx session.

LTE: GTPv2/bearer setup with IMSI X, APN Y→IP address assignment (4.4.4.4).

Thus, with respect to the PGW, there are provided two bearers on given PDN sessions. In various embodiments, allocation of traffic between the two access networks may be determined by a number of methods, such as equal-cost multipath (ECMP) hashing within the context of an “any/any” PCC rule. Further, other Policy Control and Charging (PCC) rules may be provided to allocate or direct traffic either via xDSL or LTE.

In various embodiments, one public address associated with the CPE is advertised to public network elements. This one public address is used by upstream CPE traffic as a source address for each link or bearer by which upstream traffic is communicated to the PGW.

Further, with respect to the CPE, a NAT public IP address used for the CPE, upstream traffic may be passed or otherwise allocated between the two access networks if desired. In various embodiments, substantially all traffic is allocated to a preferential access network (e.g., the xDSL access network), while traffic in excess of a threshold amount is allocated to a secondary access network (e.g., the LTE access network). In various embodiments, upstream traffic is hashed via LTE/xDSL, IPv6 DHCP PD. In various embodiments, a default any/any rules is hashed across both PDN sessions.

Within the context of the method 500 of FIG. 5, the CPE operates in substantially the same manner as that described above with respect to FIG. 4B,

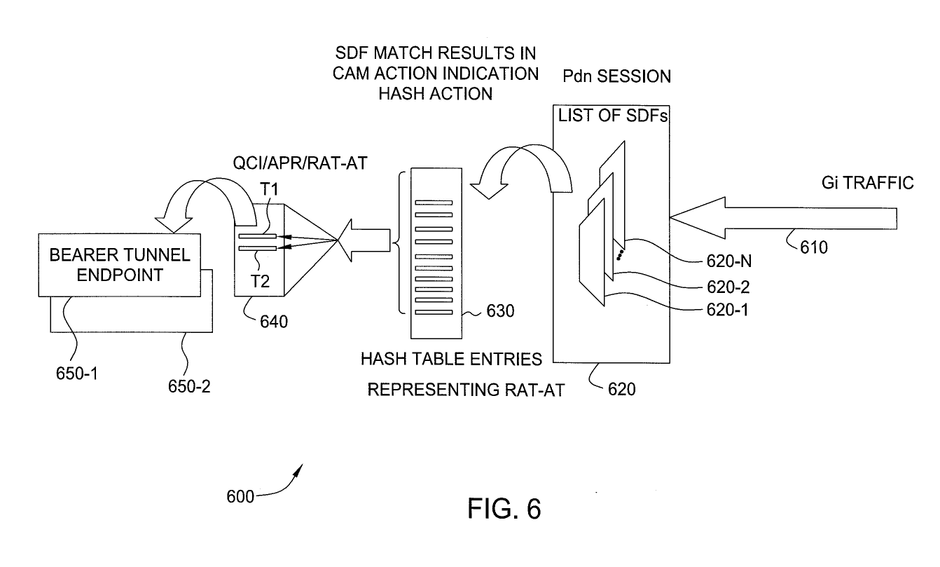

FIG. 6 depicts a graphical representation of a data plane model useful in understanding the various embodiments. Specifically, FIG. 6 depicts a data plane processing model suitable for understanding the access network traffic allocation processes occurring at the PGW, CPE or other device in accordance within the various embodiments.

Referring to FIG. 6, Gi traffic or other traffic 610 is received by a device operating in accordance with the various embodiments described herein. The packet data network session 620 may include a plurality of Service Data Flows (SDFs) depicted as SDFs 620-1 through 620-N. Each of the SDFs is associated with identification information or other information useful in hashing the SDF or portions thereof such that the SDF or portions thereof may be allocated to one or more of a plurality of bearers in communication with a destination device, such as a CPE device for downstream traffic or a PGW for upstream traffic.

In various embodiments, each SDF is associated with a QCI/ARP key (i.e., Quality of Service Class Indicator/Address Resolution Protocol key). The QCI/ARP key may be used within the context of hashing an SDF or portion thereof to thereby allocate the SDF or portion thereof to a particular bearer in communication with the destination device. That is, an entry in a hash table 630 responsive to hashing the SDF or portion thereof indicates the appropriate bearer for communicating the SDF or portion thereof to the destination device. This indication may take the form of, illustratively, a Radio Access Technology (RAT) indicator or, more generally, an Access Technology (AT) indicator. The RAT/AT indicator may be added to the existing QCI/ARP key to form a QCI/ARP/RAT (or QCI/ARP/AT) key, which key is used to direct the SDF or portion thereof to the appropriate bearer in communication with the destination device, such as one of tunnels T1 and T2 within a plurality of bearers 640 configured to forward traffic to the appropriate bearer tunnel endpoint (e.g., 650-1 or 650-2); namely, to the appropriate UE or destination device.

Various embodiments contemplate configuring “traffic hash profiles” to describe the traffic distribution across the different types of access networks. For example, a default traffic hash profile may provide for 100%/0% distribution wherein a first access type receives 100% of traffic while the second access type receives 0% traffic. The hash profiles to be expanded to include more than two access types. Various embodiments contemplate default profiles of 100%/0% for each access network.

Generally speaking, a bonded service according to the various embodiments is implemented with a data plane session having two or more default bearers capable of carrying service data flows (SDFs) for a subscriber. Allocation of traffic to the various service flows is policy-driven as provided above in the various figures. Mechanism by which the allocation is implemented may be hashing or any other mechanism suitable for selectively routing traffic flows such as service data flows or portions thereof to various upstream or downstream errors.

In various embodiments, a bonded service may be defined as a service where: (1) a UE or RG/CPE is simultaneously served by the same IP address over both 3GPP and N3GPP access networks; and (2) the PGW (not the UE) determines which IP-CAN-Type to use for a given DL IP flow. In various embodiments, UE multi-homing is provided wherein the PGW is better positioned than the UE to determine which IP-CAN-Type to use for a given DL IP flow. Generally speaking, this happens when the UE (or CPE) is served by 3GPP and N3GPP access that are stable enough such that there is no issue as to whether the network chooses the IP-CAN-Type to use for a given DL IP flow; (2) the UE or CPE cannot or does not have SDF or application flow knowledge. In these embodiments, the PGW bases its decision on (dynamic) PCRF policies or on information from AAA server.

One embodiment is well suited for use within the context of the PGW simultaneously connected to a residential gateway via both DSL and LTE, wherein upstream and/or downstream traffic is preferentially routed via the DSL bearer to threshold level approaching a maximum bandwidth of, illustratively, 100 Mb per second, wherein further traffic is routed via the LTE bearer.

The various embodiments discussed above are found applicable to numerous applications, such as supporting faster HO between 3GPP and N3GPP. That is, when a PDN connection is simultaneously set up on both 3GPP and N3GPP access networks, a sudden loss of access via a primary access network does not induce a service interruption gap for the UE to attempt a recovery operation by setting up the PDN connection again on the other access network. In this case, the various access networks may operate in active standby mode or in active/active mode, wherein active/active mode supports a higher throughput as described above with respect to the various figures.

In various embodiments, a bonded service may be associated with a UE that is multi-homed for a given IP-CAN session. However, there is one single IP-CAN session associated with the IP address/IPv6 Prefix of the UE. In this manner, the single IP-CAN session providing multiple data plane sessions allows for simple fight management for charging (Gy, Gz/Rf/Ga) and LI interfaces, for TDF interactions and so on.

In various embodiments, the bonded service provides the PGW control DL routing decisions based on PCRF instructions (thus needing the creation of a new AVP over Gx). Within the context of various embodiments, the routing decisions are communicated to the PCRF via a Routing-Rule-Install AVP. The PCRF may use this information to create/update/delete PCC rules.

The various embodiments described above generally relate to a use case wherein a CPE has both DSL and LTE access capability, such as at a residential or enterprise gateway. These embodiments provide a mechanism by which LTE bearers, when bonded with DSL bearers, provide additional bandwidth and resiliency to customers as discussed above. Many of the embodiments are also contemplated within the context of the invention.

Various embodiments contemplate 3GPP/LTE/Wi-Fi/DSL bonding services in multiple combination, such as where UE (or CPE) use both LTE and Wi-Fi together as part of a bonded service. Advantageously, by assigning one IP address to UE for use in both LTE as well as trusted Wi-Fi access, unwanted inter-Rat handover problems may be avoided. To illustrate, at present if UE such as a handset is enabled to have both LTE and Wi-Fi access it is assumed that both connections receive a separate IP address. However, in the case of a trusted WLAN where the handset communications via Wi-Fi are sent to the same PGW as LTE communications, the PGW may treat data received via multiple access networks as indicating a need for inter-RAT handover such that the PGW tears down the LTE session. Since the handset is not expecting to be disconnected from the LTE connection it tries to reconnect to the PGW, triggering at the PGW and inter-rat handover from Wi-Fi to LTE.

The various LTE/DSL bonding services described above are equally applicable to Wi-Fi/LTE bonding, Wi-Fi/3GPP bonding, Wi-Fi/LTE/DSL bonding and other multiple access network bonding services since a single IP address is used for each UE. Further, allocating the same IP address for multiple connections helps in limiting address space usage without impacting the core routing domain.

Enterprise Resilient Router Pair

Additional bonding services adapted to improve enterprise resiliency are also contemplated. For example, assume that an enterprise network includes two routers connected to a PGW for resiliency purposes. Each of these two routers are typically identified by a separate International Mobile Subscriber Entity Identifier (IMSI). That is, in contrast to the single CPE examples discussed above, each of the routers (CPEs) forming the resilient router pair is associated with a respective IMSI such that there are two disparate connections identifying two different IMSIs which may be bonded together as well to give resilience or a traffic distribution preference.

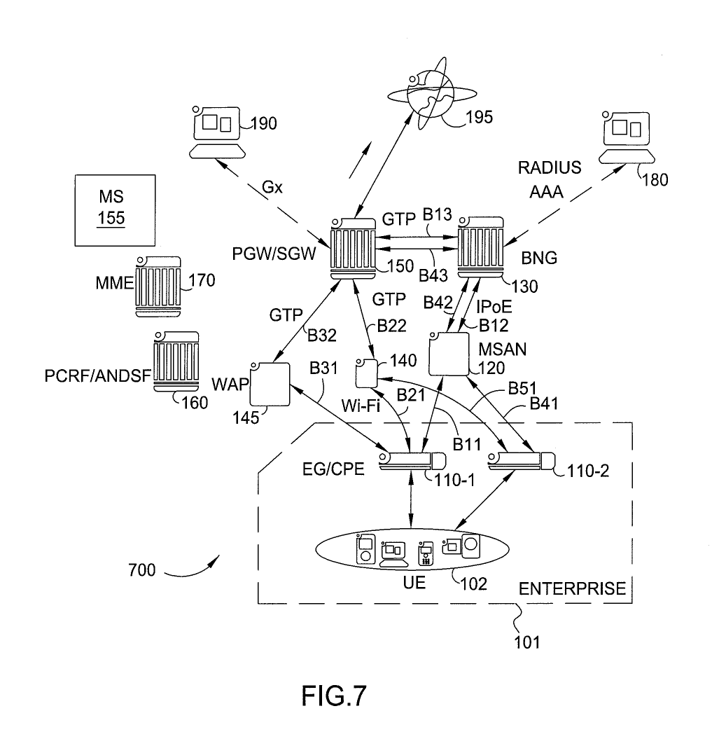

FIG. 7 depicts a high-level block diagram of a system 700 substantially the same as the system 300 depicted with respect to FIG. 3, except that FIG. 7 further discloses a second CPE (illustratively, a second enterprise router where first 110-1 and second 110-2 enterprise routers form a resilient router pair). Specifically, referring to FIG. 7, an enterprise 101 is depicted as including first enterprise router 110-1 and second enterprise router 110-2, where each of the enterprise routers 110 communicates with at least some of the UE 102. First enterprise router 110-1 is associated with a first IMSI and receives bonded services comprising bearer paths through DSL (B11, B12, B13), LTE (B21, B22) and Wi-Fi (B31, B32) access technologies. Bonded services are provided to first enterprise router 110-1 in the manner described above with respect to the various figures.

Second enterprise router 110-2 is associated with a second IMSI and receives bonded services comprising bearer paths through DSL (B41, B42, B43) and LTE (B51, B52) access technologies. Bonded services are provided to second enterprise router 110-2 in the manner described above with respect to the various figures.

PGW/SGW 150 provides a bonded session for the router 110-1 and 110-2 connections to form thereby resilient bonded session. Specifically, PGW/SGW 150 identifies that both connections are associated with enterprise 101 and, therefore, traffic destined for UE 102 with enterprise 101 may be provided via one or both of the first and second enterprise routers 110. In some embodiments, each of the enterprise routers 110 communicates with any of the UE 102. In some embodiments, each of the enterprise routers communicates with a subset of the UE 102, which subset may overlap to include commonly serviced UE 102. In various embodiments, a resilient bonded session may allocate traffic among any of the (illustratively five) bearers servicing the enterprise routers 110. In various embodiments, one of the enterprise routers 110 may operate as a primary/active router, while the other enterprise router 110 operates as a secondary/standby router. Various other configurations will also be appreciated by those skilled in the art.

In various embodiments, connections from multiple routers such as routers serving a common enterprise or portion thereof may be bonded together. In various embodiments, a bonded resilience Information Element (IE) may be associated with priority information, enterprise identification and/or other parameters.

Various embodiments contemplate providing a bonded service by determining, at a gateway device configured to support a User Equipment (UE) data plane session having multiple bearers, an allocation of UE traffic communicated by the multiple bearers according to policy information received by the gateway device, wherein each bearer is associated with a different IP Connectivity Access Network (IP-CAN); and adapting UE traffic communicated via the multiple bearers according to the determined allocation. The UA traffic may comprise any type of traffic, such as service data flows (SDFs), application flows (AFs) and the like. The IP-CANs comprise any type of access network technologies, such as those associated with Digital Subscriber Line (DSL), Wi-Fi technology, WiMAX, 3GPP/LTE, cable television and the like. Allocating may be implemented by hashing the traffic to spread a traffic load associated with the traffic across multiple bearers.

In various embodiments, policy information pertaining to the downstream traffic allocation across bearers may be provided to the SGW/PGW via one or both of a PCRF or ANDSF. In various embodiments, policy information pertaining to upstream traffic allocation across bearers may be provided to CPE or UE via one or both of the PCRF or ANDSF, or via communications propagated to the CPE or UE from the SGW/PGW. In various embodiments, downstream or upstream traffic allocations among the multiple bearers may be adapted in response to one or more of access technology congestion levels, updated policies, updated service level agreement (SLA) requirements and so on.

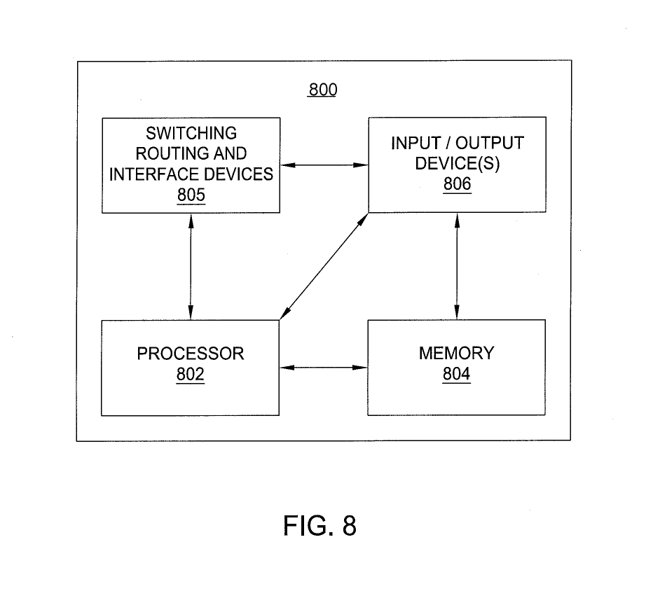

FIG. 8 depicts a high-level block diagram of a computing device, such as a processor in a telecom network element, suitable for use in performing functions described herein such as those associated with the various elements described herein with respect to the figures.

As depicted in FIG. 8, computing device 800 includes a processor element 802 (e.g., a central processing unit (CPU) and/or other suitable processor(s)), a memory 804 (e.g., random access memory (RAM), read only memory (ROM), and the like), cooperating module/process 805, and various input/output devices 806 (e.g., a user input device (such as a keyboard, a keypad, a mouse, and the like), a user output device (such as a display, a speaker, and the like), an input port, an output port, a receiver, a transmitter, and storage devices (e.g., a persistent solid state drive, a hard disk drive, a compact disk drive, and the like)).

In the case of a routing or switching device such as PGW/SGW 150, RG/CPE 110, BNG 130 and the like, the cooperating module process 805 may implement various switching devices, routing devices, interface devices and so on as known to those skilled in the art. Thus, the computing device 800 is implemented within the context of such a routing or switching device (or within the context of one or more modules or sub-elements of such a device), further functions appropriate to that routing or switching device or also contemplated and these further functions are in communication with or otherwise associated with the processor 802, input-output devices 806 and memory 804 of the computing device 800 described herein.

It will be appreciated that the functions depicted and described herein may be implemented in hardware and/or in a combination of software and hardware, e.g., using a general purpose computer, one or more application specific integrated circuits (ASIC), and/or any other hardware equivalents. In one embodiment, the cooperating process 805 can be loaded into memory 804 and executed by processor 803 to implement the functions as discussed herein. Thus, cooperating process 805 (including associated data structures) can be stored on a computer readable storage medium, e.g., RAM memory, magnetic or optical drive or diskette, and the like.

It will be appreciated that computing device 800 depicted in FIG. 8 provides a general architecture and functionality suitable for implementing functional elements described herein or portions of the functional elements described herein.

It is contemplated that some of the steps discussed herein may be implemented within hardware, for example, as circuitry that cooperates with the processor to perform various method steps. Portions of the functions/elements described herein may be implemented as a computer program product wherein computer instructions, when processed by a computing device, adapt the operation of the computing device such that the methods and/or techniques described herein are invoked or otherwise provided. Instructions for invoking the inventive methods may be stored in tangible and non-transitory computer readable medium such as fixed or removable media or memory, and/or stored within a memory within a computing device operating according to the instructions.

Various embodiments contemplate an apparatus including a processor and memory, where the processor is configured to establish multiple bearer data sessions, allocate traffic among the various bearers, interact with policy control entities, and generally perform the functions described above with respect to the PGW processing of downstream traffic, CPE processing of upstream traffic and so on. The processor is configured to perform the various functions as described, as well communicate with other entities/apparatus including respective processors and memories to exchange control plane and data plane information in accordance of the various embodiments.

Although various embodiments which incorporate the teachings of the present invention have been shown and described in detail herein, those skilled in the art can readily devise many other varied embodiments that still incorporate these teachings. Thus, while the foregoing is directed to various embodiments of the present invention, other and further embodiments of the invention may be devised without departing from the basic scope thereof. As such, the appropriate scope of the invention is to be determined according to the claims.

What is claimed is:

1. A method of providing a bonded service, comprising:
determining, at a gateway device configured to support a User Equipment (UE) data plane session having multiple bearers, an allocation of UE traffic communicated by the multiple bearers according to policy information received by the gateway device, wherein each bearer is associated with a different IP Connectivity Access Network (IP-CAN); and
adapting UE traffic communicated via the multiple bearers according to the determined allocation.

2. The method of claim 1, wherein said UE traffic comprises any of service data flows (SDFs) and application flows (AFs).

3. The method of claim 2, wherein said UE traffic comprises service data flows (SDFs), wherein at least one SDF is allocated to more than one of said multiple bearers, said at least one SDF being associated with a respective Quality of Service Class Indicator (QCI), Address Resolution Protocol (ARP) and a Radio Access Technology (RAT) indicator.

4. The method of claim 1, wherein said UE is associated with the same IP address for each of said multiple bearers.

5. The method of claim 1, wherein said UE is associated with a different IP address for each of said multiple bearers, and a single advertised loopback IP address.

6. The method of claim 1, wherein said UE is multi-homed to said gateway device.

7. The method of claim 1, wherein said gateway device comprises a provider equipment (PE) gateway device configured to allocate downstream UE traffic among said bearers.

8. The method of claim 1, wherein said gateway device comprises a Customer Premises Equipment (CPE) gateway device configured to allocate upstream UE traffic among said bearers.

9. The method of claim 7, wherein said policies are received from a Policy and Charging Rules Function (PCRF).

10. The method of claim 8, wherein said policies are received from an Access Network Discovery and Selection Function (ANDSF).

11. The method of claim 8, wherein said CPE comprises a residential gateway (RG) wherein a first bearer is associated with a DSL access network and a second bearer is associated with a 3GPP/LTE access network.

12. The method of claim 11, wherein a third bearer is associated with a Wi-Fi access point (WAP).

13. The method of claim 1, wherein said gateway device comprises a plurality of routers configured as enterprise gateway device, each of said routers allocating respective upstream traffic among said bearers.

14. The method of claim 1, further comprising:
establishing, at said gateway device, an initial data plane session for said UE each of said multiple bearers carrying receiving, at said gateway device,

15. The method of claim 1, wherein said IP-CANs comprise at least two of Digital Subscriber Line (DSL), Wi-Fi technology, WiMAX and 3GPP/LTE.

16. The method of claim 1, wherein said adapting UE traffic communicated via the multiple bearers comprises hashing UE traffic to spread a traffic load associated with the UE across a multiple bearers.

17. The method of claim 1, further comprising forwarding, toward Customer Premises Equipment (CPE), an uplink traffic policy adapted to configure said CPE to allocate upstream traffic across multiple upstream errors.

18. The method of claim 1, further comprising adapting a downstream traffic allocation among said multiple bearers in response to one or more of access technology congestion levels, service level agreement (SLA) requirements, service optimization, access technology path failure and traffic type.

19. An apparatus providing a bonded service, the apparatus comprising:
a processor and a memory, the processor configured for:
determining, at a gateway device configured to support a User Equipment (UE) data plane session having multiple bearers, an allocation of UE traffic communicated by the multiple bearers according to policy information received by the gateway device, wherein each bearer is associated with a different IP Connectivity Access Network (IP-CAN); and
adapting UE traffic communicated via the multiple bearers according to the determined allocation.

20. A telecom network element, comprising a processor configured for:
determining, at a gateway device configured to support a User Equipment (UE) data plane session having multiple bearers, an allocation of UE traffic communicated by the multiple bearers according to policy information received by the gateway device, wherein each bearer is associated with a different IP Connectivity Access Network (IP-CAN); and
adapting UE traffic communicated via the multiple bearers according to the determined allocation.

21. A tangible and non-transient computer readable storage medium storing instructions which, when executed by a computer, adapt the operation of the computer to provide a method, comprising:
determining, at a gateway device configured to support a User Equipment (UE) data plane session having multiple bearers, an allocation of UE traffic communicated by the multiple bearers according to policy information received by the gateway device, wherein each bearer is associated with a different IP Connectivity Access Network (IP-CAN); and
adapting UE traffic communicated via the multiple bearers according to the determined allocation.

22. A computer program product wherein computer instructions, when executed by a processor in a telecom network element, adapt the operation of the telecom network element to provide a method, comprising:
determining, at a gateway device configured to support a User Equipment (UE) data plane session having multiple bearers, an allocation of UE traffic communicated by the multiple bearers according to policy information received by the gateway device, wherein each bearer is associated with a different IP Connectivity Access Network (IP-CAN); and
adapting UE traffic communicated via the multiple bearers according to the determined allocation.
